(19) United States
(12) Patent Application Publication
(10) Pub. No.: US 2021/0126460 A1
(43) Pub. Date: Apr. 29, 2021

(54) EFFICIENT HIERARCHICAL DISTRIBUTED POWER STORAGE

(71) Applicant: BreakEats LLC, Sunnyvale, CA (US)

(72) Inventors: Robert James Fanfelle, San Carlos, CA (US); Ezra Robert Gold, Sunnyvale, CA (US)

(73) Assignee: BreakEats LLC, Sunnyvale, CA (US)

(21) Appl. No.: 16/665,497

(22) Filed: Oct. 28, 2019

(51) Int. Cl. H02J 3/16; H02J 3/32; H02J 3/01

(52) U.S. Cl. CPC H02J 3/16; H02J 3/01; H02J 3/32

(57) ABSTRACT

An electrical energy storage device for use in an electrical distribution grid where storage may be located across various voltage transitions throughout the network, enabling energy to bypass stepdown transformers, monitoring on both sides of a transformer, and power conditioning to optimize transformer and grid performance.

### BACKGROUND

Systems now exist to store power from solar, wind and other electrical sources. In existing alternating current (AC) electricity distribution systems, any energy storage is charged and discharged at the same AC voltage. There are many applications where the stored electricity will be used or supplied at a different AC voltage than the AC voltage connected to the storage system. For example, power may be taken from the utility distribution voltage during off-peak hours and stored for use at mains voltage in a home or business during peak hours. Another example is energy stored from a mains voltage source, such as home solar, and used at utility distribution voltage to supply other utility customers.

For AC electricity to be used at another voltage than the voltage at which it is released from storage or generated, it must pass through a transformer to convert between the voltages. Between 2% and 10% of electricity passing through the transformer is lost as heat in the transformer. An AC power distribution system utilizing conventional storage methods incurs losses as storage is charged and discharged, in addition to losses through the transformer. There is a need for an energy storage solution that reduces loss while maintaining the ability to charge from and discharge power to transmission lines that operate at differing voltage levels.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a power distribution grid with conventional storage deployment 100 in accordance with one embodiment.

FIG. 2 illustrates a power distribution grid with novel storage deployment 200 in accordance with one embodiment.

FIG. 3 illustrates a transformer delta configuration 300 in accordance with one embodiment.

FIG. 4 illustrates a steady-state condition 400 in accordance with one embodiment.

FIG. 5 illustrates a draw-from-low scenario 500 in accordance with one embodiment.

FIG. 6 illustrates a release-to-low scenario 600 in accordance with one embodiment.

FIG. 7 illustrates a draw-from-high scenario 700 in accordance with one embodiment.

FIG. 8 illustrates a release-to-high scenario 800 in accordance with one embodiment.

FIG. 9 illustrates a draw-from-high-and-low scenario 900 in accordance with one embodiment.

FIG. 10 illustrates a release-to-high-and-low scenario 1000 in accordance with one embodiment.

FIG. 11 illustrates a release-to-high/draw-from-low scenario 1100 in accordance with one embodiment.

FIG. 12 illustrates a draw-from-high/release-to-low scenario 1200 in accordance with one embodiment.

FIG. 13 illustrates an energy storage device 1300 in accordance with one embodiment.

FIG. 14 illustrates a power transfer loss scenarios 1400 in accordance with one embodiment.

FIG. 15 illustrates a power conditioning 1500 in accordance with one embodiment.

### DETAILED DESCRIPTION

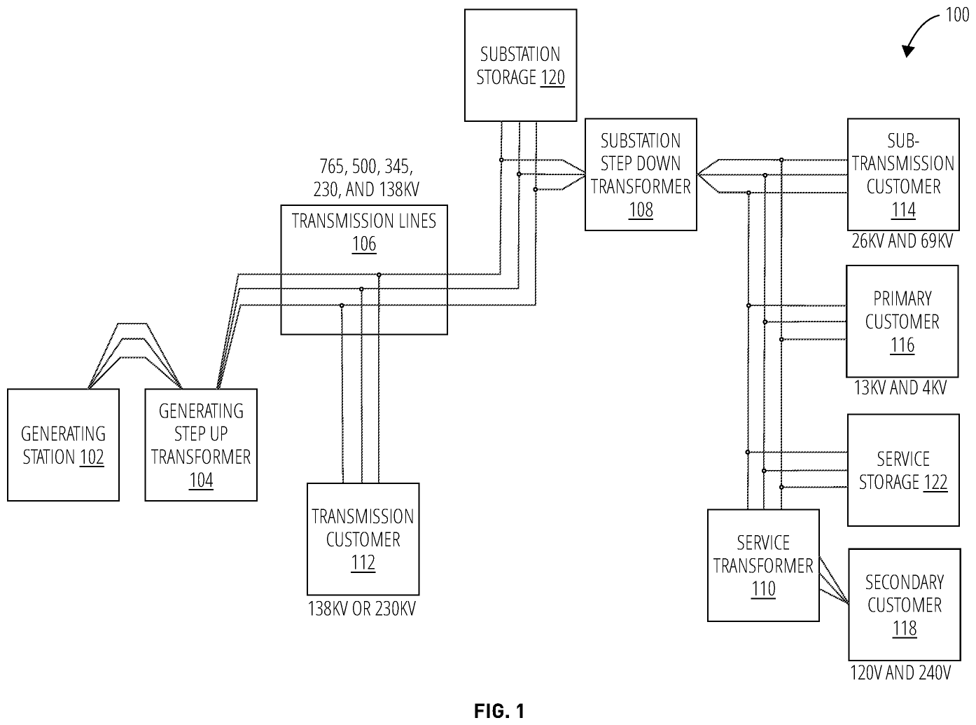

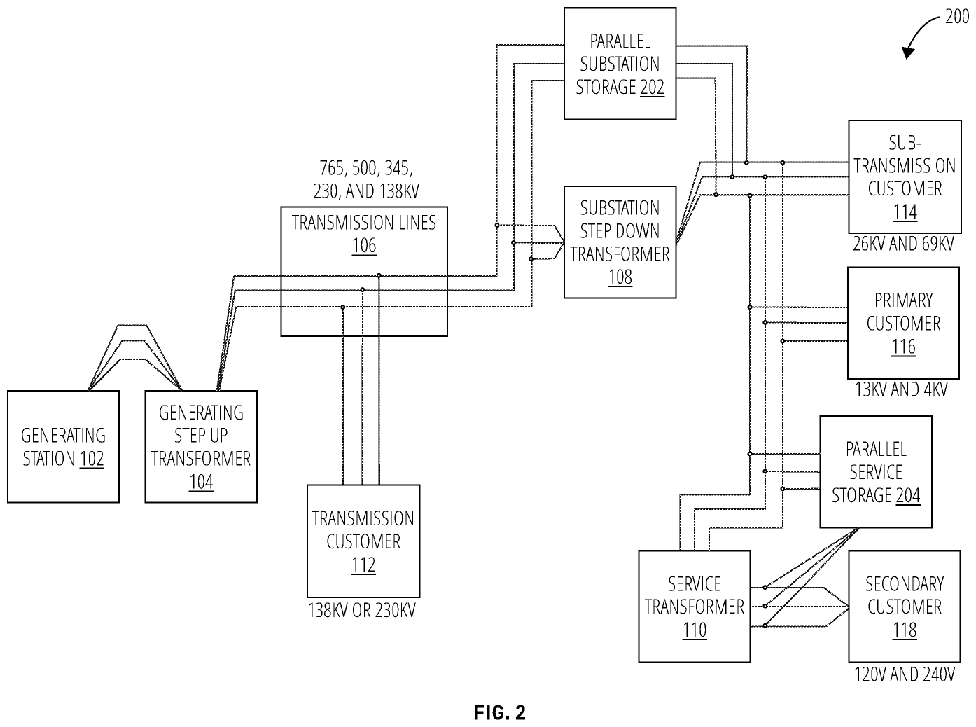

FIG. 1 depicts an example of conventional storage deployment 100 in a utility grid. A novel storage deployment 200 at conversion points between a higher voltage branch of the power grid and a lower voltage sub-branch of the grid is depicted in FIG. 2. A number of benefits are realized in the novel storage deployment 200, as described in more detail below.

Embodiments disclosed herein utilize energy storage devices charged at one AC voltage and discharged at a different AC voltage. “Energy storage device” refers to a device utilizing charge storage devices and logic to selectively control charging and discharging of the charge storage devices. The electrical energy may be stored by various mechanisms such as batteries, mechanical (e.g., utilizing a flywheel), non-battery chemical mechanisms, etc. “Charge storage devices” refers to devices that store energy for later controlled release. Such devices include batteries, ultracapacitors, and flywheels. In one application electrical distribution grid energy storage devices are located across various voltage transition points throughout the network, as depicted in FIG. 2.

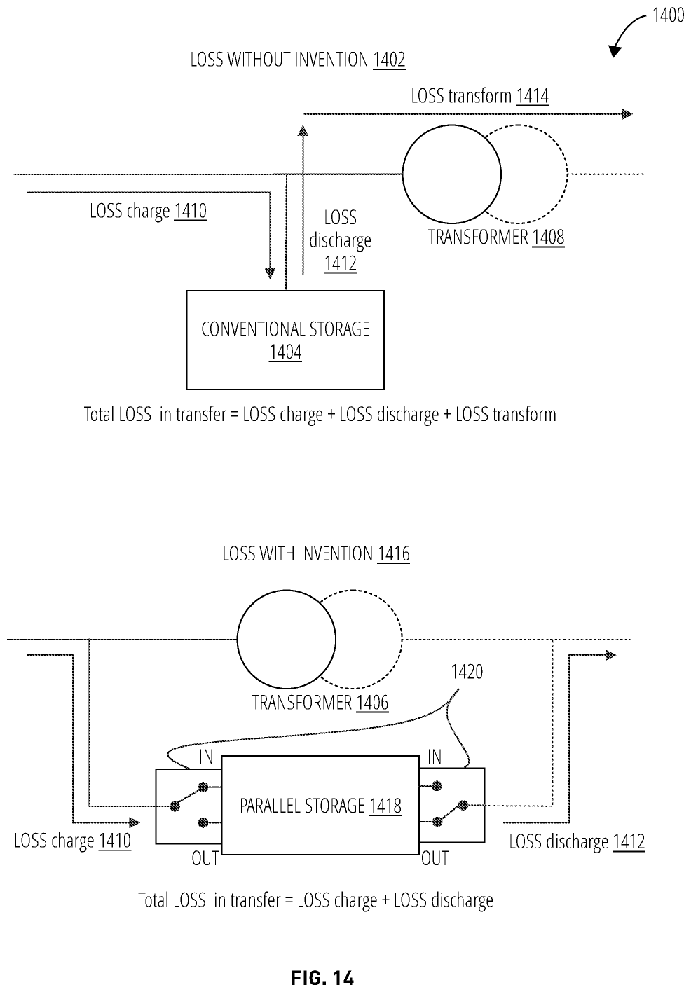

AC electricity is passed through transformers to convert between voltage levels. Between 2% and 10% of electricity passing through a transformer may be lost as waste heat. By charging the disclosed storage system at the voltage where energy is available and delivering that stored energy at the voltage where it will be used, the disclosed system bypasses the transformer. This improves the round trip efficiency of the energy storage system by an amount proportional to the transformer inefficiency. FIG. 14 depicts the potential for reduced energy loss in such systems as compared to conventional storage solutions.

An energy storage device may be designed to store and release energy at either voltage of a transformer. With this capability, the round trip efficiency advantages may be achieved when storing and releasing energy in one or both directions across the transformer. In such configurations the system may be deployed to similar effect as conventional energy storage solutions.

A storage node connected in parallel to a transformer may also monitor power conditions at the inputs and outputs of the transformer and apply stored energy to improve the conditioning of the signals into or out of the transformer.

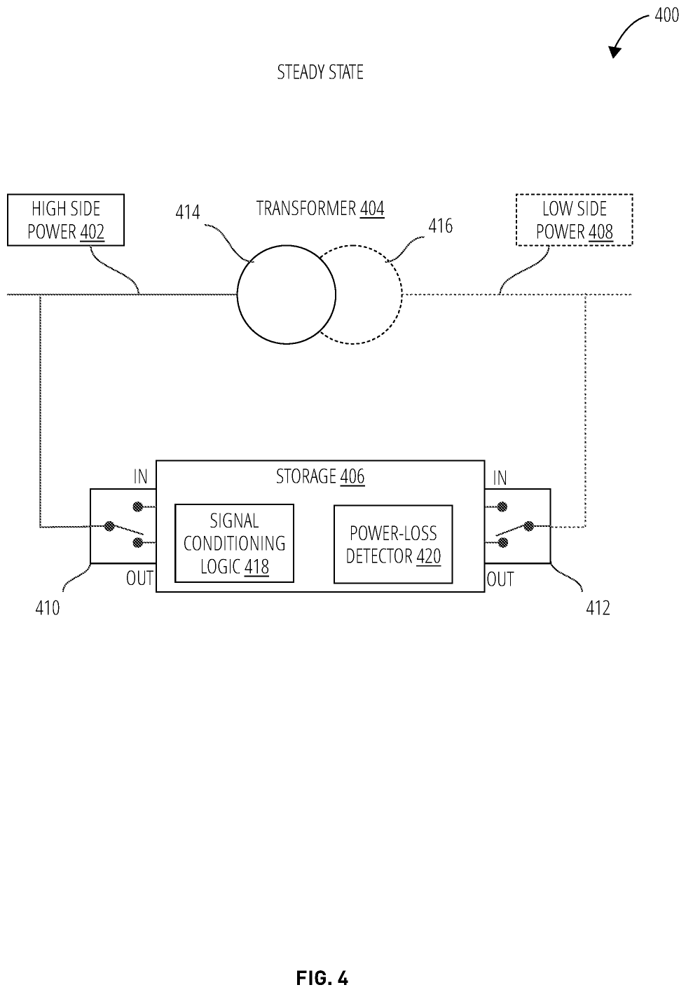

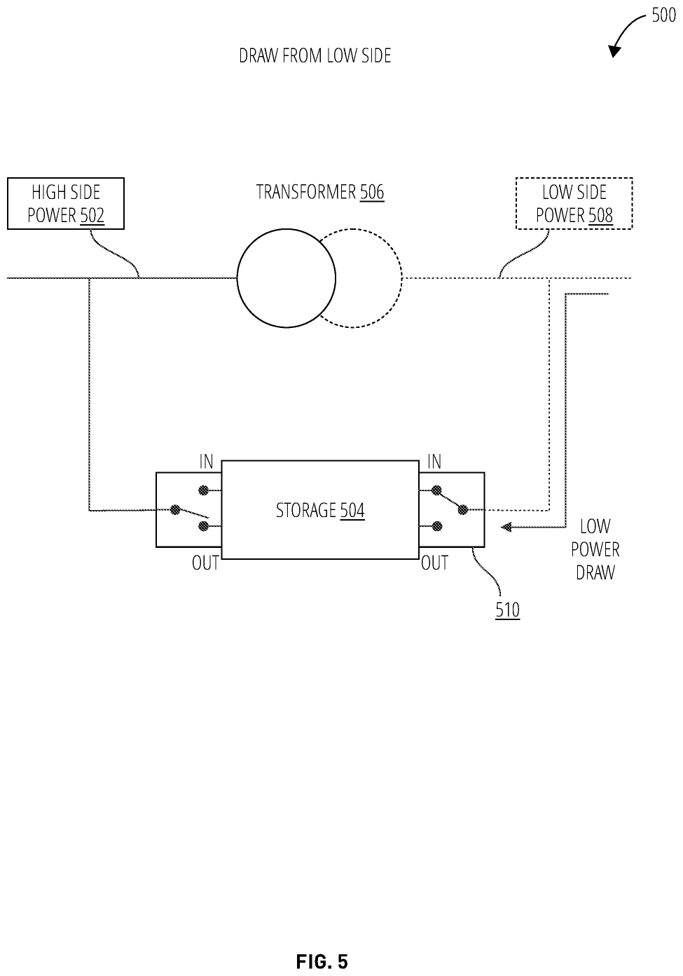

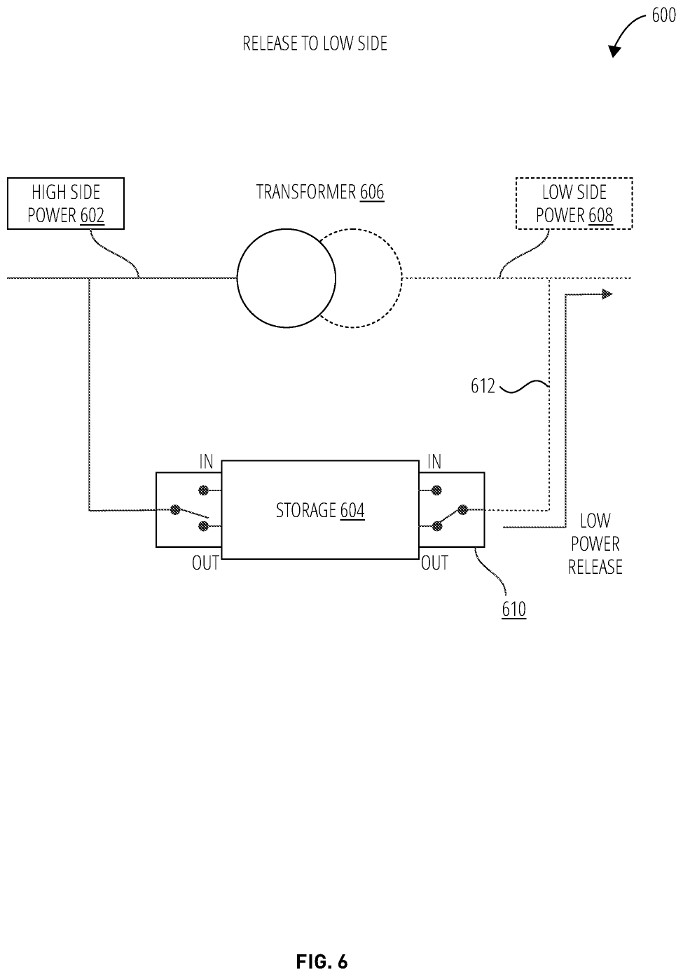

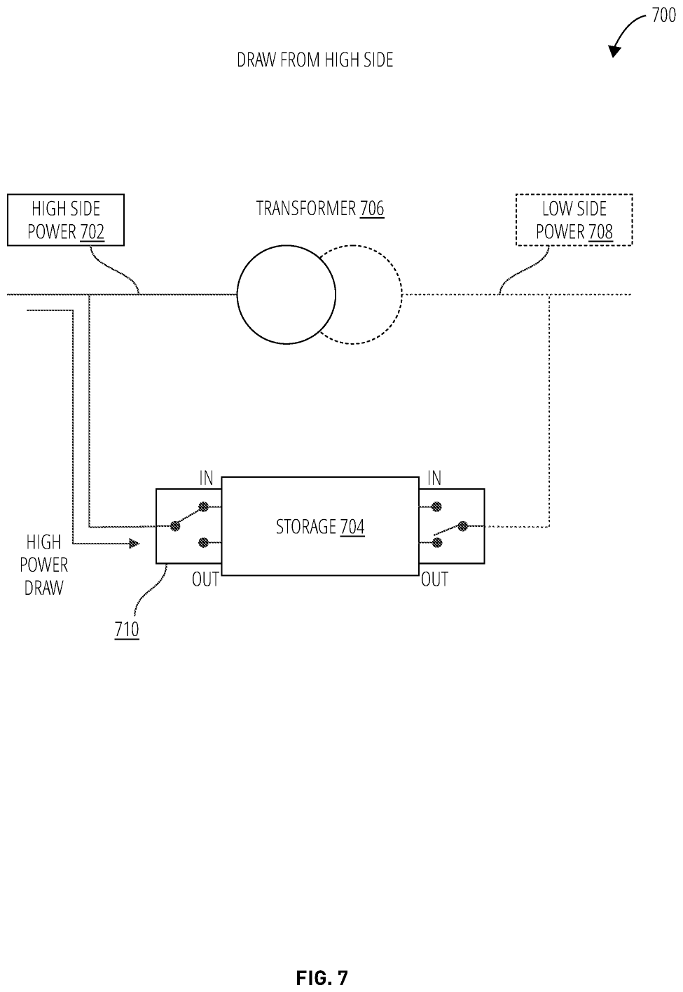

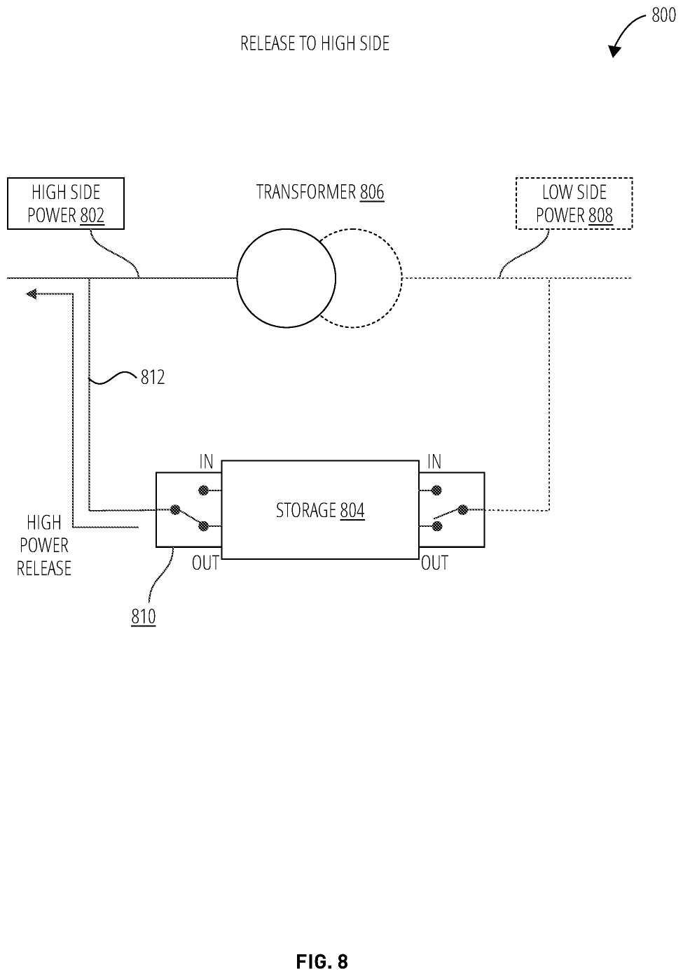

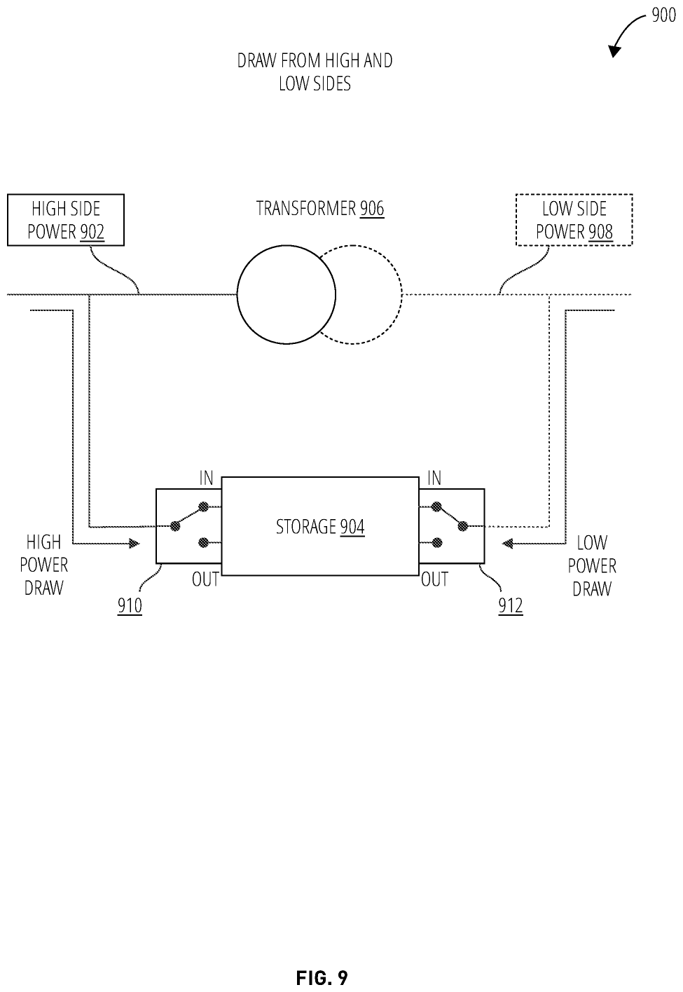

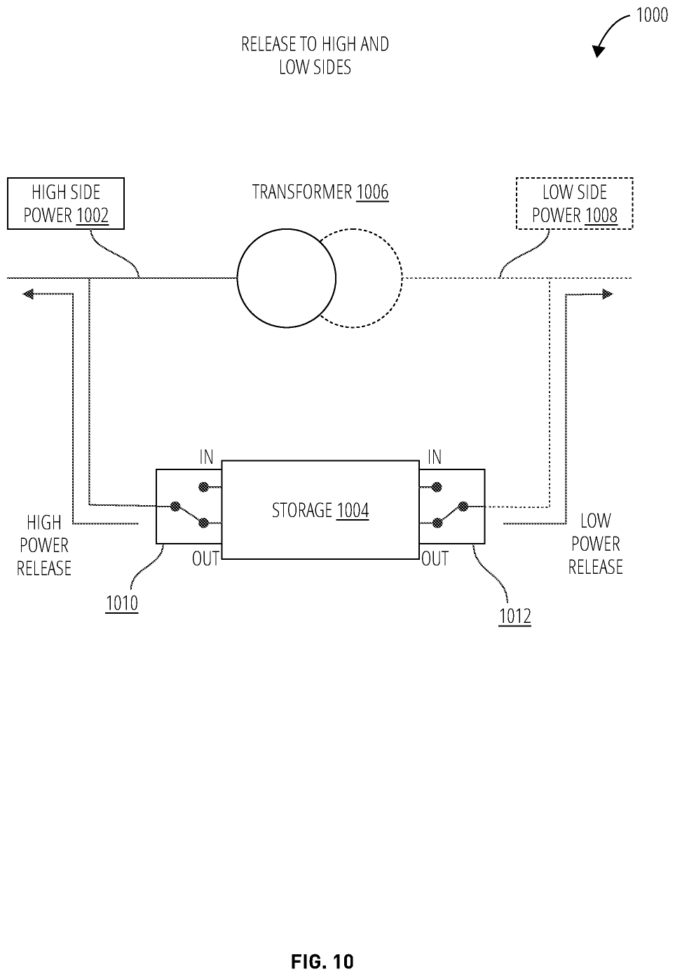

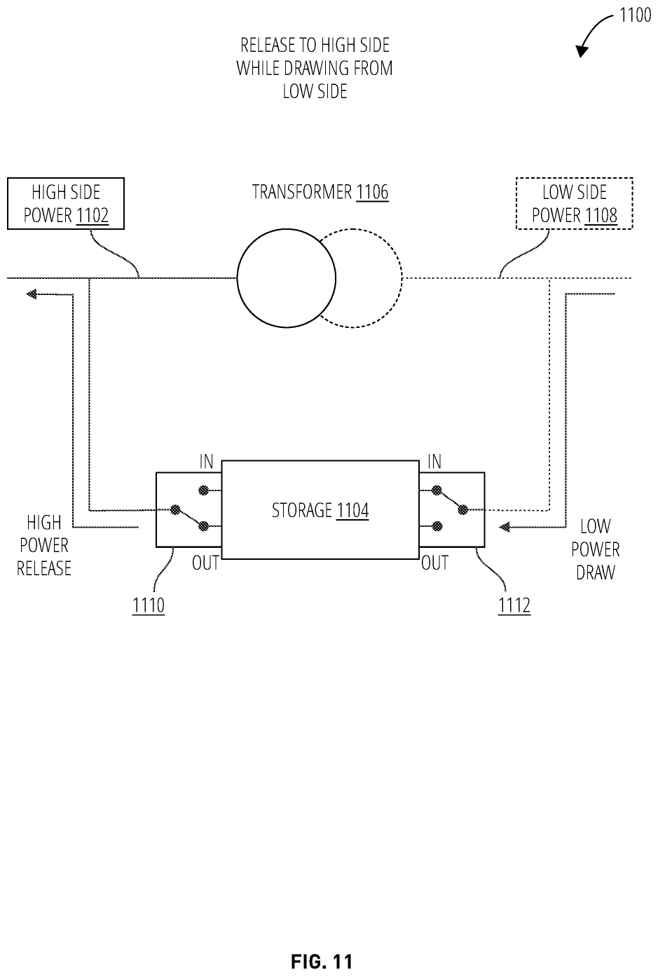

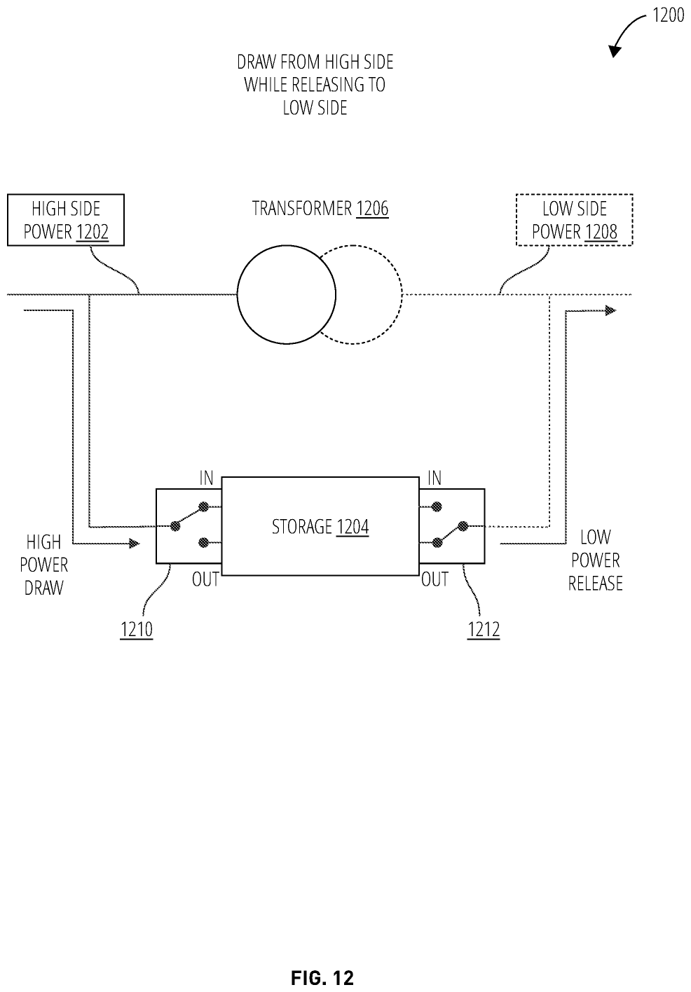

When operating in a steady state, as depicted in FIG. 4, power generated or transmitted at a high voltage may pass through a transformer to supply power at a lower voltage level. The energy storage device may charge from the lower voltage lines for storage, as depicted in FIG. 5. The energy storage device may release energy to the lower voltage lines for transmission as shown in FIG. 6. The energy storage device may charge from the high voltage lines as depicted in FIG. 7 and/or release energy to the high voltage lines for transmission as depicted in FIG. 8. The energy storage device may also charge from both sides of the transformer, as depicted in FIG. 9, and may discharge to one or both sides, as depicted in FIG. 10. The charge and discharge may occur simultaneously as depicted in FIG. 11 and FIG. 12. The energy storage device may be designed with the flexibility to perform under each of these use cases, as needed.

For example, the energy storage device may be disposed in parallel with a service transformer. The energy storage device may charge from either the distribution feed or the service line, or both. This energy storage device may in turn discharge energy to either the distribution feed, or the service line, or both.

An energy storage device operating in the above conditions may be able to sense the voltage and/or current of the attached higher voltage grid lines and the lower voltage grid lines. The device may use stored energy to condition power on the grid lines based on a detected condition. For example, the device may apply stored energy to reduce total harmonic distortion, increase power factor, or perform other signal or power conditioning to improve the efficiency of the transformer. A small amount of energy released from storage at strategic times may improve overall system efficiency such that losses and distortions are substantially offset.

The energy storage device may communicate with other grid components at other locations on the grid and apply information about the grid state received from these other components to address grid-wide issues by releasing energy to the grid, or consuming energy from the grid. For example, grid-wide brown out (low system voltage) or impending brown out may be sensed at other locations on the grid, and stored energy may be released by one or more energy storage devices to mitigate the brown out. Alternately, grid-wide over-voltage may be sensed, and storage (consumption) of power may be initiated or increased to mitigate the over-voltage condition. Various energy storage devices throughout the grid may coordinate with one another to mitigate such conditions.

The energy storage device may monitor line conditions to develop a model of transformer state and efficiency. It may then use the developed model to improve the performance of the transformer. An energy storage device may analyze transformer operation and communicate with grid management systems. It may provide time-shifted energy release or consumption at a higher efficiency than conventional grid-attached storage. It may for example store energy when the cost of energy is low (e.g., during times of low grid energy utilization) and apply this energy later to improve the efficiency of the grid or transformer, when energy costs are higher.

The disclosed devices and systems may reduce wasted energy. In a preferred embodiment, the transformer and the energy storage device remain connected with the transformer operating as a passive component, always connected simultaneously to the energy storage device at both its high and low voltage terminals. The energy storage device actively monitors voltage changes on the low voltage terminal(s) and actively compensates by injecting or draining power to maintain low leg voltage and signal integrity, to urge conditions toward a lower difference from an ideal transformer operating voltage and minimize or eliminate current passing through the transformer. Herein “leg” refers to the transmission lines on a particular side of a transformer, which could be the lines between two transformers.

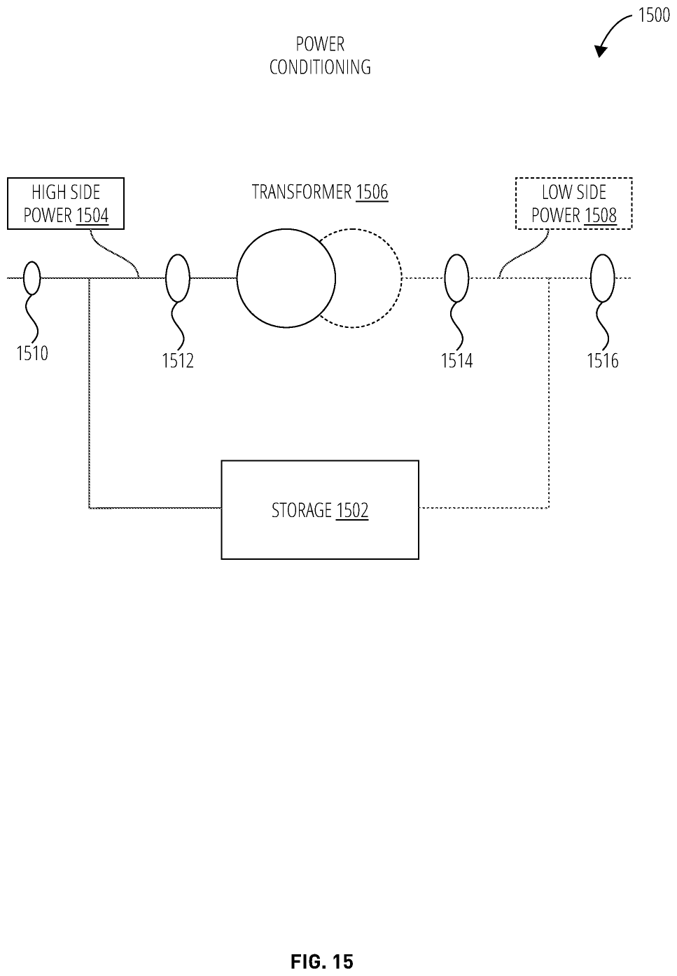

This may involve prediction of anticipated voltage and/or current demands (either in the energy storage device or using another grid component) to proactively inject energy into, or remove energy from, the low leg to optimize for the desired condition (e.g., balance between power draw through transformer vs. power factor correction/local storage reserves/network reserves/local or network efficiency). Power conditioning is depicted for example in FIG. 15.

The energy storage device may also or alternatively monitor voltage changes on the high leg and actively compensate by raising and lowering voltage on the low leg, within desired ranges, to urge the state toward lower power consumption by the transformer. The drain on stored energy may be limited to a certain threshold to ensure sufficient reserves (e.g., for time shifting and brown/black out/power conditioning).

The energy storage device may also or alternatively monitor voltage and current of the low leg and high leg and actively compensate by injecting energy into the low leg and/or drawing energy from the high leg. This may be done to condition the power supplied to a nearby transformer on one or both of the high leg and low leg connections of that transformer.

Using the system disclosed herein, loss may be reduced through each transformer traversal, as depicted in FIG. 14. Multiple customers may be served by a single storage solution. The system may provide a statistical multiplexing effect. This may allow for less total energy storage requirements than the aggregate of peak storage required by individual customers and their associated traversal losses.

Stored energy may be pushed from the utility and/or pulled from end customers. This may reduce the need for distribution-level grid upgrades. Reduced need for upgrades may enable deferral or elimination of upgrades at both local and trunk level, and may facilitate adaptation of existing infrastructure for an increasing portion of renewable and inconsistent power generation (e.g., solar, wind generation). The disclosed system may add a buffer to improve real-time management of grid loads, and may provide load balancing for nearby branches and sub-branches of the grid, upstream, downstream and adjacent to each energy storage device.

The system disclosed may use flywheels or batteries or other storage methods. It may provide conditioning for generation points downstream from the main grid, which may mitigate phase alignment and power factor issues, and may enable utilities to points of access to the main grid. Decentralization of energy storage using the disclosed system may increase the fault tolerance of the overall grid.

The disclosed system may reduce transmission loss. Power may travel a shorter distance over the electrical grid. Locally generated power may be consumed locally, even when generation and consumption are time-shifted. Conversion losses may be reduced, as power injection may occur on the same sub-branch as where use takes place. The conversion steps up and down may also be reduced. Grouped units of the disclosed energy storage device may cooperate to adjust power phase and quality to clean up “dirty” power conditions on the consumer side of the distribution grid. Integration and communication with other grid components such as sensors and operation centers may assist in the coordinated storage and release of energy. In one embodiment, short periods of high power draw may be buffered, improving transmission efficiency.

An energy storage device may over time learn the characteristics of a spanned (parallel coupled) transformer. Examples include temperature characteristics and time constants of the transformer transfer function. The storage device may not need to be physically located on or near the transformer. It may, for example, be mounted on a different pole than the transformer, provided it is coupled to both the high and low voltage terminals of the transformer. The energy storage device may manage power line communication (PLC) across a transformer. It may for example be configured to terminate, repeat, or pass through PLC waveforms across the transformer.

The following description utilizes three phase grids and grid devices by way of example. The invention and techniques are generally applicable to two phase and four phase grids and devices as well as higher phase technologies.

FIG. 1 depicts a conventional storage deployment 100 in accordance with one embodiment. Components of the conventional deployment include a power generation facility 102, a step-up transformer 104, transmission lines 106 comprising main grid lines 124, a substation step-down transformer 108 between the main grid lines 124 and the consumer grid lines 126, a service transformer 110, a transmission customer 112, a sub-transmission customer 114, a primary customer 116, a secondary customer 118, substation energy storage 120, and service energy storage 122.

Power may be generated at the power generation facility 102 through combustion of fossil fuels, hydroelectric power conversion, wind or solar farms, and other techniques known in the art. This power may be passed through a step-up transformer 104 to high voltages for transmission across long distances via the transmission lines 106. The transmission lines 106 may carry power at levels in the hundreds of kilovolts. A transmission customer 112 may use 138 kV or 230 kV power, for example, and may draw power directly from the transmission lines 106.

At a power substation, the transmission lines 106 may run to a substation step-down transformer 108 to convert the received power to lower voltage levels. The substation may include substation energy storage 120, which is conventionally deployed at the end of a T-junction, as shown in FIG. 1. The substation step-down transformer 108 reduces voltage levels to the 4 kV to 69 kV range, for example, for consumption by a typical sub-transmission customer 114 or primary customer 116.

Power lines from the substation step-down transformer 108 may also run to a storage service transformer 110 in order to step down the voltage levels even further, for example to the 120V and 240V ranges typically consumed by a secondary customer 118 such as a residence or business. Service energy storage 122 may be deployed on the higher-voltage side of a service transformer 110, again on a T-junction as shown.

FIG. 2 depicts a novel storage deployment 200 in accordance with one embodiment. The novel deployment is depicted for an energy storage device 202 and an energy storage device 204. Other arrangements and numbers of energy storage devices in accordance with the invention are of course possible.

The primary components of the utility grid are the same as depicted in FIG. 1. However the energy storage device 202 and energy storage device 204 are disposed in parallel with the substation step-down transformer 108 and service transformer 110, respectively.

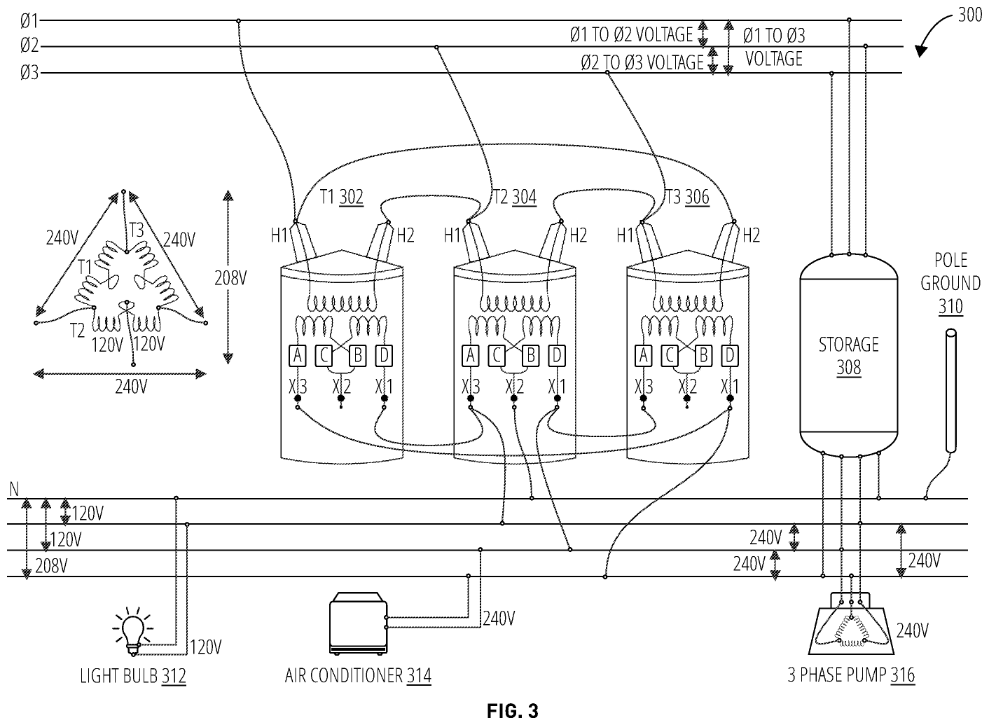

FIG. 3 depicts a transformer delta configuration 300 in accordance with one embodiment. The depiction shows a first transformer 302, a second transformer 304, a third transformer 306, a parallel-installed energy storage device 308, a pole ground 310, a light bulb 312, an air conditioner 314, and a three-phase pump 316. The transformer delta configuration 300 is provided as an example but other configurations are also supported, such as delta-wye transformer configurations.

These components are depicted in a configuration such that power on high voltage lines is stepped down to 120V, 208V, and 240V levels by arranging the three transformers in a delta configuration. The 120V line may be used to power typical small appliances such as the light bulb 312 in an indoor lamp. The 240V line may be used to power the air conditioner 314 or the three-phase pump 316.

FIG. 4 illustrates a steady-state condition 400 in accordance with one embodiment. The steady-state condition 400 comprises a power distribution grid with a high-voltage side 402 on the primary winding side 414 of a step-down transformer 404, a low-voltage side 408 of the power distribution grid on a secondary winding side 416 of the step-down transformer 404, and an energy storage device 406 in parallel with the primary winding side 414 and secondary winding side 416.

Power flows from high-voltage side 402 through the step-down transformer 404 to the low-voltage side 408. The energy storage device 406 comprises a switched port 410 to the high-voltage side 402 of the step-down transformer 404 and a switched port 412 to the low-voltage side 408 of the step-down transformer 404. In the steady-state condition 400 these ports are both switched “OFF” meaning the energy storage device 406 is not drawing energy from either side of the step-down transformer 404.

The energy storage device 406 also comprises signal conditioning logic 418 and a power-loss detector 420 that will be described in further detail below.

FIG. 5 depicts a draw-from-low scenario 500 in accordance with one embodiment. Power flows across the step-down transformer 506 from the high-voltage side 502 to the low-voltage side 508 during power distribution over a power distribution grid. The energy storage device 504 draws energy for charging from the low-voltage side 508 through the switched port 510.

In the draw-from-low scenario 500 and subsequent scenarios described below power need not be flowing through the transformer. For example the transformer may be “blown” and non-functional, or the high-side feeder supplying the transformer may not be receiving power. Thus it should be understood that although the scenarios are described as occurring when power flows through the transformer, this need not be the case. The energy storage device can generally release energy onto a transmission line with or without power flowing through the transformer, and can charge even if the transformer is “off”, blown, or otherwise not transmitting power, so long as there is power on the line from which the energy storage device is drawing energy.

FIG. 6 depicts a release-to-low scenario 600 in accordance with one embodiment. Power again flows across the step-down transformer 606 from the high-voltage side 602 to the low-voltage side 608 during power distribution over the power distribution grid. However in the release-to-low scenario 600 the energy storage device 604 releases stored energy to the low-voltage side 608 through the switched port 610.

FIG. 7 depicts a draw-from-high scenario 700 in accordance with one embodiment. As before power flows across the step-down transformer 706 from the high-voltage side 702 to the low-voltage side 708 during power distribution over the power distribution grid. However in the draw-from-high scenario 700 the energy storage device 704 draws energy for charging from the high-voltage side 702 through the switched port 710.

FIG. 8 depicts a release-to-high scenario 800 in accordance with one embodiment. Power flows across the step-down transformer 806 from the high-voltage side 802 to the low-voltage side 808 during power distribution over the power distribution grid. However in the release-to-high scenario 800 the energy storage device 804 releases stored energy to the high-voltage side 802 through the switched port 810.

FIG. 9 depicts a draw-from-high-and-low scenario 900 in accordance with one embodiment. As power flows across the step-down transformer 906 from the high-voltage side 902 to the low-voltage side 908 during power distribution on the power distribution grid, the energy storage device 904 draws energy for charging from both the high-voltage side 902 and the low-voltage side 908 via the switched port 910 and the switched port 912, respectively.

FIG. 10 depicts a release-to-high-and-low scenario 1000 in accordance with one embodiment. As power flows across the step-down transformer 1006 from the high-voltage side 1002 to the low-voltage side 1008 during power distribution on the power distribution grid, the energy storage device 1004 releases stored energy to both the high-voltage side 1002 and the low-voltage side 1008 via the switched port 1010 and the switched port 1012, respectively.

The switched ports may thus operate as switch-controlled inputs and switch-controlled outputs of the energy storage device. There may be multiple such ports on both the high side and low side of the energy storage device, depending on the number of phases of the transmission lines.

FIG. 11 depicts a release-to-high/draw-from-low scenario 1100 in accordance with one embodiment. As power flows across the step-down transformer 1106 from the high-voltage side 1102 to the low-voltage side 1108 during power distribution on the power distribution grid, the energy storage device 1104 releases stored energy to the high-voltage side 1102 while drawing energy from the energy storage device 1104 via the switched port 1110 and the switched port 1112, respectively.

FIG. 12 depicts a draw-from-high/release-to-low scenario 1200 in accordance with one embodiment. As power flows across the step-down transformer 1206 from the high-voltage side 1202 to the low-voltage side 1208 during power distribution on the power distribution grid, the energy storage device 1204 draws energy from the high-voltage side 1202 and releases energy to the low-voltage side 1208 via the switched port 1210 and the switched port 1212, respectively.

In each of these scenarios, an energy storage device may be disposed in parallel with a service transformer that draws from the source and distribution terminals of a number of service transformers in the power distribution grid supplying individual homes and businesses. In a case where multiple home or business service lines are attached to a single service transformer, individual voltage and current sensing of each service line may be used to monitor each line independently. In some installations the energy storage device may be coupled between extra-high-voltage (EHV) transmission lines and distribution feeder lines.

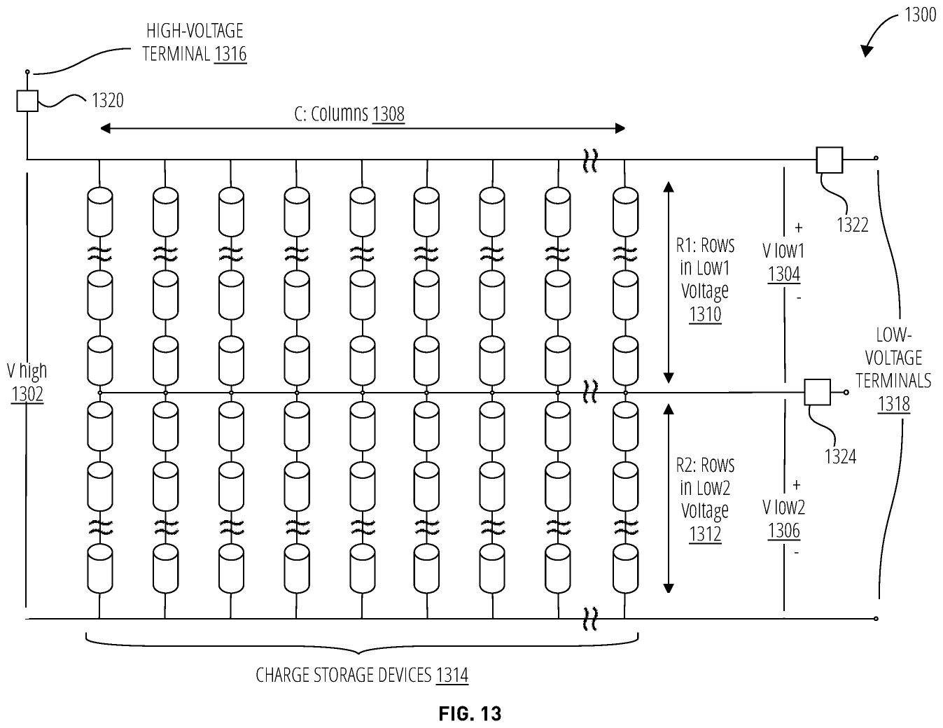

FIG. 13 depicts an energy storage device 1300 in accordance with one embodiment. For an energy storage device that utilizes batteries the configuration of the battery cells may be arranged to supply the switched ports servicing both the high line and low line across the transformer.

For example, there may be sufficient battery cells coupled in series at the switched port to the high line into the transformer to bring the voltage V high 1302 close or equal to the high line voltage, reducing the complexity and improving the efficiency of the conversion. Likewise there may be sufficient battery cells coupled in series at the switched port to the low line into the transformer to bring the voltage V 1ow2 1306 close or equal to the low line voltage. In the depicted example energy storage device 1300, V 1ow2 1306 is the voltage at the switched port to the low voltage line and V high 1302 is the voltage at the switched port to the high voltage line, and V high 1302=V 1ow2 1306+V low1 1304.

In FIG. 13, C: Columns 1308 denotes multiple columns of serially connected batteries wired in parallel to provide total energy storage capacity. R1: Rows in Low1 Voltage 1310 denotes the number of rows of batteries connected in series, which determines the voltage level applied on the V low1 1304 leg of the power distribution grid. R2: Rows in Low2 Voltage 1312 denotes the number of rows of batteries connected in series, which determines the voltage level on the V 1ow2 1306 leg. V low1 1304+V 1ow2 1306=V high 1302. In a case where there are more than two V lows (e.g., more than three phase grids), the sum of all V lows=V high.

In a preferred mode, all values of Vlow are configured to be substantially the same. When V low1 1304 is not equal to V 1ow2 1306, concerns may include loading imbalances on the load legs. However, the benefits of differing Vlows may include lower costs and simultaneous synchronization between the legs. When V low1 1304 equals V 1ow2 1306, there may be no risk of imbalance loading. This energy storage device 1300 configuration may allow further saving of efficiency of conversion by avoiding transformer inefficiencies for voltage conversion.

When the Vlow terminals and the Vhigh terminal are electrically isolated at their outputs, the batteries may be simultaneously connected to said output terminals to supply Vhigh and a set of Vlow values on the grid. Isolation can be supplied by the transformer servicing different voltages or phases. Alternately isolation may be separate conversion circuits with output terminals converged to a single voltage or phase.

FIG. 14 depicts power transfer loss scenarios 1400 in accordance with one embodiment. A scenario is depicted for the loss without invention 1402, where conventional storage 1404 is connected to the high voltage network on one side of the transformer 1408, and consumption is on low voltage network on the other side of transformer 1408. A second scenario is shown for loss with invention 1416 in which parallel storage 1418 is connected across the high and low sides of a transformer 1406.

The power transfer loss scenarios 1400 illustrate benefits of system disclosed herein. Port switches 1420 may be located on the input and output ports of the parallel storage 1418 to regulate the flow of power. In a scenario in which the parallel storage 1418 needs to store energy from the high voltage side and release it to the low voltage side, the loss without invention 1402 scenario incurs losses including LOSS charge 1410 (the energy loss from charging the conventional storage 1404), LOSS discharge 1412 (the energy lost discharging the conventional storage 1404), and LOSS transform 1414 (the transformer loss). The stored energy is released back into the higher voltage side and must still be stepped down by the transformer 1408.

In the loss with invention 1416 scenario the released energy bypasses the transformer. Thus only the LOSS charge 1410 and LOSS discharge 1412 are incurred.

FIG. 15 depicts power conditioning 1500 in accordance with one embodiment. The power conditioning 1500 is facilitated by supplying power from energy storage device 1502 or drawing power into energy storage device 1502 at either side of the transformer 1506. Power may be conditioned by simultaneously drawing power from one side of the transformer and delivering power to the other side of the transformer. A low electrical resistance between the energy storage device 1502 and the transformer enables voltage to be sensed as a function of current through the charge (i.e., high side 1504 or V1) and discharge (i.e., low side 1508 or V2) circuits. These measurements may indicate voltage at the connections between the transformer 1506 and the energy storage device 1502.

Current may be sensed directly with auxiliary current sensors depicted as system V1 current sense 1510, transformer V1 current sense 1512, transformer V2 current sense 1514, and system V2 current sense 1516. These auxiliary current sensors may be in series or may be in parallel (ex. inductive) with the transformer 1506 terminals, the latter allowing installation without interrupting operation. An alternate current sensing topology is to measure system current to the transformer 1506 and power generation facility 102 as a system. Transformer 1506 current is calculated as system current minus energy storage device 1502 current in this topology.

Examples of power conditioning 1500 that may be carried out include voltage regulation, power factor correction, noise suppression, and transient impulse protection. Based on a sensed voltage and/or current condition on one side of the transformer 1506, the energy storage device 1502 may draw energy from one side of the transformer 1506 and/or release energy to the other side of the transformer 1506. Herein, “power factor” refers to the ratio of the real power absorbed by the load to the apparent power flowing through the grid to the load. A power factor of less than one indicates the voltage and current are not in phase, reducing the instantaneous product (power) of the two. Real power is the instantaneous product of voltage and current and represents the capacity of the electricity for performing work. Apparent power is the average product of current and voltage. Due to energy stored in the load and returned to the grid, or due to a non-linear load that distorts the wave shape of the current drawn from the grid, the apparent power may be greater than the real power. A negative power factor occurs when the load (e.g., the downstream power customer) generates power, which then flows back into the transmission lines.

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

“Logic” is used herein to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

1. A system comprising:
a transformer in a power distribution grid, the power distribution grid comprising a high-voltage side and a low-voltage side; and
an energy storage device in parallel with the transformer, wherein the energy storage device comprises:
at least one power input port coupled in parallel to a first set windings of the transformer;
at least one power output port coupled in parallel to a second set of windings of the transformer.

2. The system of claim 1, the energy storage device further comprising a switch-controlled output to selectively discharge to the second set of windings of the transformer.

3. The system of claim 1, the energy storage device comprising a switch-controlled input to selectively charge from the first set of windings of the transformer.

4. The system of claim 1, the energy storage device comprising a power-loss detector.

5. The system of claim 1, wherein the energy storage device is a three phase device.

6. The system of claim 1, the energy storage device comprising:
a first switch-controlled inputs to selectively charge from the high-voltage side of the power distribution grid;
a second switch-controlled input to selectively charge from the low-voltage side of the power distribution grid;
a first switch-controlled output to selectively discharge to the high-voltage side of the power distribution grid; and
a second switch-controlled output to selectively discharge to the low-voltage side of the power distribution grid.

7. The system of claim 1, further comprising logic to perform signal conditioning on one or both of the high-voltage side of the power distribution grid and the low-voltage side of the power distribution grid.

8. The system of claim 7, wherein the signal conditioning comprises harmonic distortion correction.

9. The system of claim 7, where in the signal conditioning comprises power factor improvement.

10. The system of claim 1, wherein the energy storage device comprises two or more banks of batteries arranged to provide a high-voltage output, and one or more low-voltage outputs.

11. An energy storage device comprising:
two or more banks of charge storage devices arranged to supply a high-voltage terminal, and two or more low-voltage terminals;
the high-voltage terminal comprising a first parallel connection to a first set of windings of a transformer; and
one or more of the low-voltage terminals comprising a second parallel connection to a second set of windings of the transformer.

12. The energy storage device of claim 11, further comprising a switch to selectively charge the charge storage devices from the high-voltage terminal.

13. The energy storage device of claim 11, further comprising a power-loss detector.

14. The energy storage device of claim 11, further comprising signal conditioning logic to perform harmonic distortion correction on signals passing between the first set of windings and the second set of windings.

15. The energy storage device of claim 11, further comprising signal conditioning logic to perform power factor improvement on signals passing between the first set of windings and the second set of windings.

16. A method comprising:
operating an energy storage device in parallel with a transformer in a power distribution grid, the power distribution grid comprising a high-voltage side and a low-voltage side, wherein the energy storage device comprises:
at least one high-voltage power port coupled in parallel to high-voltage windings of the transformer;
at least one low-voltage power port coupled in parallel to low-voltage windings of the transformer.

17. The method of claim 16, further comprising operating a switch to selectively charge the energy storage device from the high-voltage side of the power distribution grid.

18. The method of claim 16, further comprising operating a switch to selectively discharge the energy storage device into the low-voltage side of the power distribution grid.

19. The method of claim 16, further comprising operating a switch to selectively discharge the energy storage device into the high-voltage side of the power distribution grid.

20. The method of claim 16, further comprising operating a switch to selectively charge the energy storage device from the low-voltage side of the power distribution grid.

21. The energy storage device of claim 11, further comprising a switch to selectively discharge the charge storage devices into one or more of the low-voltage terminals.

22. The energy storage device of claim 11, further comprising a switch to selectively discharge the charge storage devices into the high-voltage terminal.

23. The energy storage device of claim 11, further comprising a switch to selectively charge the charge storage devices from one or more of the low-voltage terminals.
